(19) United States
(12) Patent Application Publication
(10) Pub. No.: US 2015/0140250 A1
(43) Pub. Date: May 21, 2015

(54) METHOD OF MANUFACTURING CORRUGATED BOARD

(71) Applicant: GMC Marketing Limited, London (GB)

(72) Inventors: Michael Ramos-Gonzalez, Essex (GB); Wayne Connelly, Gloucester, NJ (US); David J. Pain, Essex (GB)

(73) Assignee: GMC Marketing Limited, London (GB)

(21) Appl. No.: 14/370,908

(22) PCT Filed: Jan. 4, 2013
(86) PCT No.: PCT/GB2013/000004

§ 371 Date: Jul. 7, 2014

(30) Foreign Application Priority Data
Jan. 6, 2012 (GB) GB1200177.2

(51) Int. Cl. B31F 5/04; B32B 7/06; B32B 37/00; B32B 7/04; B32B 37/12; B32B 37/26; B32B 7/12; B32B 29/08

(52) U.S. Cl. CPC B31F 5/04; B32B 7/12; B32B 7/06; B32B 29/08; B32B 7/045; B32B 37/12; B32B 37/26; B32B 37/0076; B32B 2037/268
USPC 428/41.8; 156/60

(57) ABSTRACT

A method of manufacturing corrugated board with an integrated adhesive layer on one side overlaid by a peelable release-liner comprising the steps of constructing a laminate comprising a liner stock suitable for adhesive bonding to a cardboard medium, an adhesive layer and a peelable release liner; and applying the laminate to at least one side of a corrugated medium.

### FIELD OF THE INVENTION

The present invention relates to a method of manufacturing corrugated board. More especially the invention relates to a manufacturing process for corrugated board having one or more self adhesive surface. The method involves in some part an extension of conventional corrugated board manufacturing processes to add adhesive functionality to the product; in particular, to provide an in-line process for manufacture of corrugated board with a peelable release-liner on one or more sides which upon removal exposes a pressure-sensitive or similar adhesive layer which enhances the functionality of the board for subsequent mounting, construction, assembly or similar applications.

### BACKGROUND OF THE INVENTION

Corrugated board products are used extensively for a wide range of applications. Fundamentally, corrugated board is comprises a fluted paper core, laminated between and bonded to inner and outer paper face liners.

The following description qualifies the outer face liner of the board as a “single liner,” and the inner face liner as the “double liner”. The fluted core is termed the “corrugated medium.”

The conventional process for manufacturing corrugated board is a roll fed process which uses sequentially a single facer glue unit and a double backer glue unit.

A web of the medium to be corrugated is fed from a take-off roll through cooperating corrugator rolls. The resulting corrugated medium then has adhesive applied before being laminated to a web of the (outer) single liner in a single facer glue unit.

As can be seen in FIG. 1, the output from the single facer unit is a laminate web of single-face corrugated board, ie. the (outer) single liner 1 combined with the (fluted) corrugated medium 2. This laminate web is then fed (either in-line or as a separate manufacturing process) into a double backer glue unit where adhesive is applied to the corrugated medium before being further laminated to a web of (inner) double liner.

As can be seen in FIG. 2, the output from the double backer glue unit is a composite laminate web of single-walled corrugated board, the fluted medium 2 being sandwiched between and bonded to inner and outer face liners 1, 3.

This web is further processed, whereby the adhesive bonds between the liners and the fluted medium are cured. The finished web may then be slit, scored and chopped to provide finished corrugated boards of dimension to suit their further processing or end-use.

Pressure sensitive adhesives and double-sided tapes may be laminated to the outside surfaces of the finished corrugated board in order to make it self-adhesive for subsequent mounting, construction, assembly or similar applications.

The typical known method of laminating adhesives or tapes to corrugated board is to attach them to one or more face liners of the finished corrugated board, either at the ‘dry end’ of the corrugator, or during an off-line process with separate laminating equipment, or by manual application. The separate steps involved in such lamination processes add greatly to the cost of the laminated product, by adding material costs, increasing handling and processing time and by increasing the percentage of waste material produced.

The present invention seeks to provide an in-line technique at the ‘wet-end’ of the corrugated board manufacturing process for manufacture of corrugated board with a peelable release-liner on one or more sides which upon removal exposes a pressure-sensitive or similar adhesive layer which enhances the functionality of the board for subsequent mounting, construction, assembly or similar applications.

Additionally, the present invention addresses the need for a low-cost self-adhesive corrugated board material for use in mounting, construction, assembly or similar applications.

### STATEMENT OF INVENTION

According to one aspect of the invention, there is provided a method of manufacturing corrugated board comprising comprising the steps of:
constructing a laminate comprising a liner stock suitable for adhesive bonding to a cardboard medium, an adhesive layer and a peelable release liner; and
applying the laminate to at least one side of a corrugated medium.

Preferably the adhesive layer comprises a pressure sensitive adhesive.

Preferably the peelable release liner is siliconised.

Preferably the method further comprises the step of applying at least one further assembly comprising liner and corrugated medium to another side of the first corrugated medium.

### BRIEF DESCRIPTION OF DRAWINGS

Embodiments of the invention will now be described, by way of example only, with reference to the accompanying figures in which:

FIG. 1 is an end view of a portion of a conventional single-face corrugated board;

FIG. 2 is an end view of a portion of a conventional single-walled corrugated board;

FIG. 3 is an end view of a portion of laminate constructed in accordance with an embodiment of the present invention;

FIG. 4 is an end view of a portion of a single-walled corrugated board with integral adhesive layer(s) and release liner(s) constructed accordance with an embodiment of the invention;

FIG. 5 is an end view of a portion of a conventional double-walled corrugated board; and

FIG. 6 is an end view of a portion of a double-walled corrugated board with integral adhesive layer(s) and release liner(s) constructed in accordance with an embodiment of the invention.

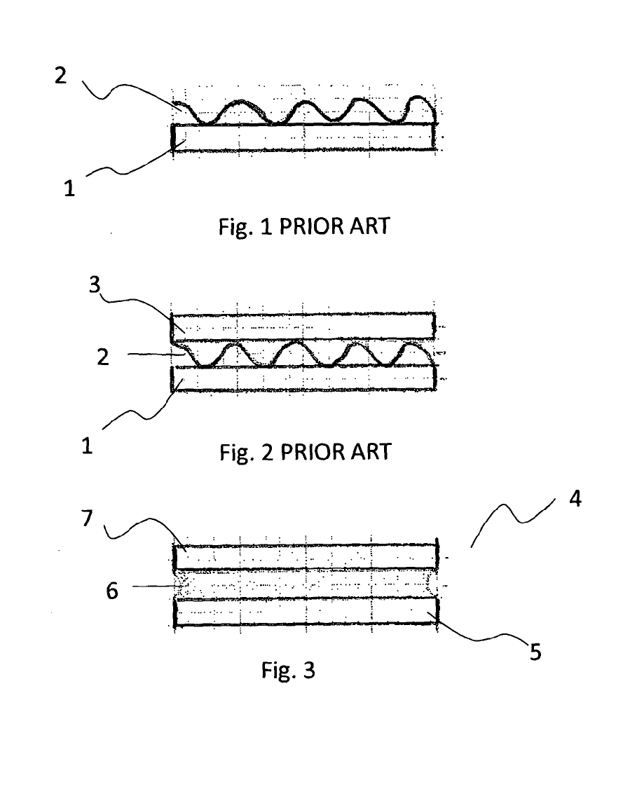

### DETAILED DESCRIPTION OF EMBODIMENTS OF THE INVENTION

The present invention relates to an in-line process for manufacture of corrugated board with a peelable release-liner on one or more sides which upon removal exposes a pressure-sensitive or similar adhesive layer which enhances the functionality of the board for subsequent mounting, construction, assembly or similar applications.

A laminate constructed in accordance with the process (hereinafter described) is shown in FIG. 3. The laminate 4 comprises a liner stock 5 suitable for adhesive bonding to the corrugated medium (for example, without limitation, kraft paper), a pressure sensitive or similar adhesive layer 6 and a peelable (siliconised or similar) release liner 7.

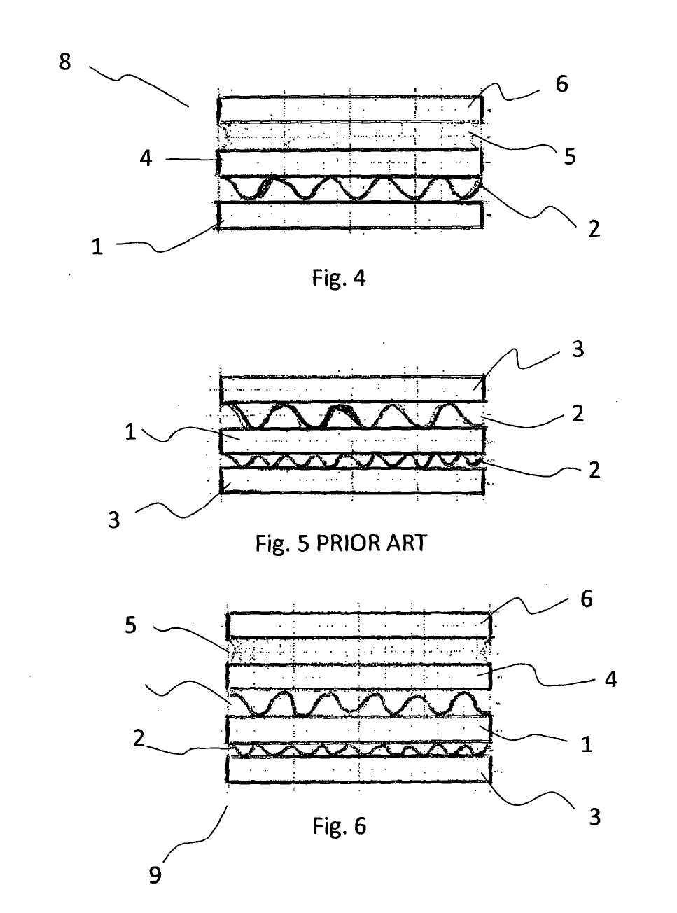

The process involves substitution of one or both of the face liners 1 of a single wall corrugated board, within the conventional corrugated board manufacturing processes, with the laminate 4. An example of an assembly created as a result of the process is illustrated in FIG. 4. It comprises a single-walled corrugated board 8 with an integral adhesive layer 6 and a release liner 6.

It will be appreciated that the corrugated board may comprise more than one adhesive layer and/or release liner.

A further embodiment of the invention relates to substitution of one or both of the face liners 1 of a double-wall or multi-wall corrugated board, within the conventional corrugated board manufacturing processes, with the laminate 4. An example of an assembly created as a result of the process is shown in FIG. 6.

The assembly comprises a double-wall (or multi-wall) corrugated board 9 with an integral adhesive layer 5 and release liner 6.

It will be appreciated that the corrugated board may have more than two walls and may comprise more than one adhesive layer and/or release liner.

A further embodiment of the invention relates to substitution of the inner liner within the process of off-line, roll-fed lamination of single-face corrugated board, with the laminate 4, thereby creating a finished assembly comprising a single-walled corrugated board with an integral adhesive layer 5 and release liner 6 (see FIG. 4).

It should be understood that variations and modifications within the spirit and scope of the invention, beyond those discussed herein, may occur to those skilled in the art to which the invention pertains. Accordingly, all expedient modifications readily attainable by one versed in the art from the disclosure set forth herein are to be included as further embodiments of the present invention.

1. A method of manufacturing corrugated board providing an adhesive layer overlaid by a peelable release liner, the method comprising the steps of constructing a laminate comprising a liner stock suitable for adhesive bonding to a cardboard medium, an adhesive layer and a peelable release liner; and bonding the laminate to at least one side of a fluted medium.

2. A method according to claim 1, wherein the fluted medium has a single fluted structure without any face liner.

3. A method according to claim 1, wherein the adhesive layer comprises a pressure sensitive adhesive.

4. A method according to claim 2, wherein the peelable release liner is silicon.

5. A method according to claim 1, further comprising the step of applying at least one further assembly comprising a liner and corrugated medium to another side of the fluted medium.

6. A corrugated board with an adhesive layer on one side overlaid by a peelable release-liner, constructed in accordance with the method of claim 1.
